(19) United States
(12) Patent Application Publication
(10) Pub. No.: US 2010/0060013 A1
(43) Pub. Date: Mar. 11, 2010

(54) Procedure and equipment for water/wind generators' performance improvement with the addition of a pneumatic system

(76) Inventor: Pál Tamás Csefkó, Budapest (HU)

Correspondence Address: Scott Caridi, 735 Blanch Ave, Norwood, NJ, 07648, US

(21) Appl. No.: 12/455,848

(22) Filed: Jul. 13, 2009

(30) Foreign Application Priority Data
Sep. 10, 2008 (HU) P 0800557

(51) Int. Cl. F03D 9/00; F03B 13/00

(52) U.S. Cl. 290/55; 290/54; 290/44; 290/43

(57) ABSTRACT

Performance and equipment for the improvement of performance of (15) wind and/or water machines, with an (5) additional pneumatic system, with utilization of kinetic energy arisen by (16) wind and/or water, with use of (8) the produced and compressed air stored in the (9) supporting column and/or in (11,13) external containers, thereby it increases the efficiency factor. This procedure and equipment possess that feature that all of the units are settled onto the same (12) crankshaft connected through several electronically controlled clutches and/or (2a,b) Hardy-disks to an (5) air compressing pneumatic compressor, a (1) voltage inducing generator and a (7) double-functional motor-generator (7), that of which functions at the same time as a starting-engine. It is still characteristic to the (15) wind machine, that the procedure becomes functional at smaller (16) wind than a bigger one necessary to start moving the fins, due to the technology, with use of the (8) compressed air stored in the (11,13) containers and/or of the electricity stored in an (14) accumulator bank.

### AREA OF APPLICATION

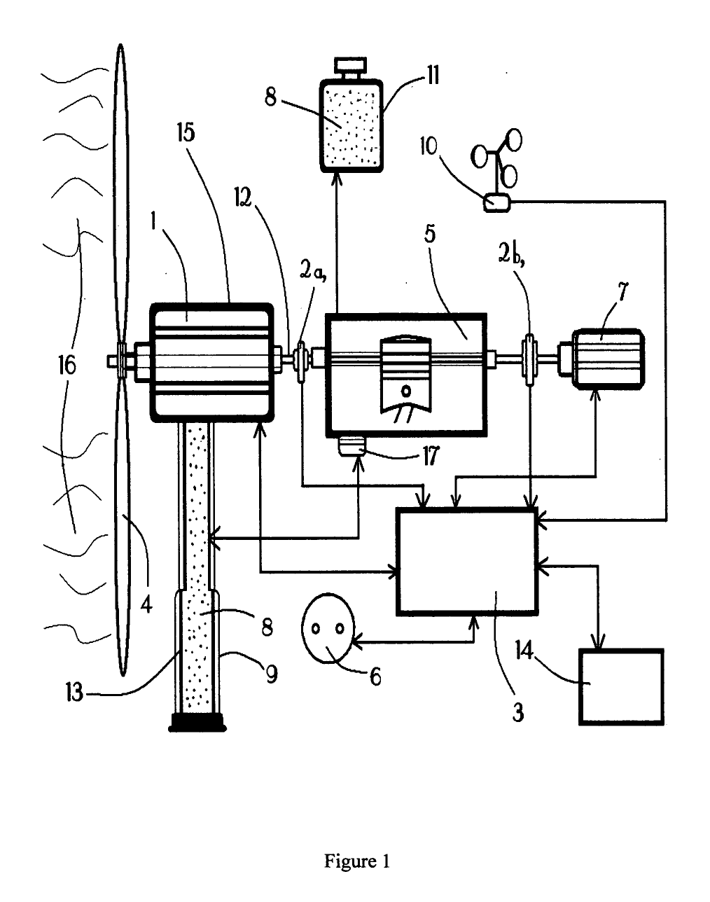

This invention can be applied in certain places where by way of force (i.e. wind, water, etc.) generated mechanical rotating motion arises. Through this process energy will be produced and stored without applying chemical technologies. The invention presented on FIG. 1 shows wind generators. Hydroelectric power plants could be used as well, but in that case energy would be produced through the application of kinetic energy with the use of water instead of wind.

### STATUS OF THE PRESENT TECHNOLOGY

The patent registered under the No. P 04 02455 describes a solution that is integral part of the wind machine, its compressed cavities constitute a flowing ventilation system. On the bottom of the column, air entrance slots, while on the end of the fins outlets are designed. The performance of the wind machine is increased by the pumping gap gasket constructed between the head end and the wind wheel hub that bites into the head.

According to patent referred above, the wind is only being channeled through and neither stored, nor compressed. Moreover, no generator and no compressor are set on one axis and neither the double functional driving motor-generator. Furthermore, the supporting column does not function as an air storing unit either. This invention however includes all functions mentioned above.

### SOLUTION ON THE INVENTION

The aim of the invention is—compared to applied procedures to date—to offer more economical solution for the production and storage of electric energy, with use of wind and/or water. The solutions give the potential to store energy produced with use of wind and/or water or of any kind of kinetic energy, in a non-chemical way, like in the case of accumulators. Through the application of the present solution, the service time of the wind machine will be extended as a result of two distinct factors: It is able to produce energy at lower wind speeds, since the starting of the wind machine fins requires higher speed of wind, than to maintain rotation at a particular speed. It has been achieved naturally through the use of wind sensors and starter-engine. The second solution is the production of electric energy trough the utilization of the stored air.

Another beneficial characteristic of the present patent is that the storage of the compressed air is taking place in the supporting column. The electric starter can also be used as a generator in the present invention; however, a sole or combined use of the generator and the starter in the wind machine is also supported. The mechanical rotating motion stemming from the stored air will be transformed into electricity. Due to this, the energy production period increases and through that the so-called dale period will reduce.

### DESCRIPTION OF THE FIGURE

The FIGURE illustrates a summarized description of the invention's parts and their functional links for an example of wind machines.

It can be observed that on the drawing that the machine moving 16 wind drives through the machine 4 fins the machine 1 generator, the extended part of the generator 12 main axis joins through an electronically controlled clutch 2a and/or a Hardy-disk in the driving shaft of the 5 compressor, by way of that the motion arisen by the wind raises not only electric energy in the wind wheel generator, but thereby also the compressor performs air compression. Thereafter it joins through another electronically controlled clutch 2b and/or through a Hardy-disk in the shaft of the electric starter 7 that also functions as a generator. The system provides for that the wind wheel could also start up the wind wheel at smaller wind, if the wind-speedometer 10 gives such an instruction through the 3 controlling electronic unit. The 3 controllers and the central processing unit provide for the accurate controls taking also the wind-force into consideration in order that the rotation could be maintainable by way of the wind yet. An inner power source joins the system yet, in the present case 14 batteries, that provide not only the control with energy, but they can also regulate the air 8 stored in 11,13 air containers through 17 decompressing and regulating valves, e.g. onto starting the 15 wind wheels at a little wind.

### DESCRIPTION OF THE INVENTION

The invention is based on such equipment and procedure that aims to improve the performance of the machines driven by wind and/or water, with the installation of an additional pneumatic system.

We have shown a wind machine in the present case, but it can be applied likewise at water machines. According to the FIGURE, a pneumatic 5 compressor and a double-functional 7 driving motor-generator join onto the 12 crankshaft of the 15 wind machine 1 generator through electronically controlled 2a,b clutch and/or Hardy-disks. The 3 processing central unit decides on the basis of the data received from the 10 wind-gauge, whether it starts up the wind-wheel 4 fins with use of the 7 driving-engine through the 2a,b clutch and/or Hardy-disks. The mechanical motion 16 arisen by the wind/or water generates, through the wind wheel 4 fins, not only electricity but at the same time air compression by driving the 1 generator of the 15 wind machine. One of the energy storing elements of the 15 wind machine is the 14 accumulator that stores the emergent energy on a chemical way for the 3 controlling and regulating central unit. The other energy storing element thereof is the pneumatic air 5 compressor, that stores the energy in form of compressed 8 air. The compressed 8 air is placed in the supporting 9 column of the 15 wind machine, in an internal 13 container and/or in external storing 11 containers of it. In calm periods, when no air movement is available, we develop voltage with use of the 8 air stored and compressed in the 11,13 containers as well as with use of the pneumatic 5 compressor and the double-functional 7 driving motor-generator, and secure on the 6 outputs.

### IMPLEMENTATION OF THE INVENTION

On the FIGURE shown in the picture, a transformed wind machine is presented and its application is described below:

The starting signal sensed by the 10 wind-speedometer, respectively arisen by a relevant wind speed arrives at the 3 processing unit. The electronic centre issues the instruction due to the sign on a suitable measure to switch on the 7 electric starter. The 7 electric starter rotates the wind-wheel 4 fins driven by the 15 wind machine at the end of the 1 generator axis, through the electronically controlled 2a,b clutch and/or Hardy-disks in the equipment. The reason for this solution is that much bigger wind is needed here to the starting of the wind machine, than to the maintenance of the rotation. Wind machines operated on the basis of this method possess much bigger energy production than the traditional ones. The wind machine brought into motion can already supply the energy continuously, while—depending on the wind speed, respectively also independently—the pneumatic system and the 5 compressor are adjustable. It can compress, respectively store 8 air with use of the electronically controlled 2a,b clutch and/or Hardy-disks in the 11,13 containers. The 8 air compressed on such a way can also be usable later for energy production, respectively for starting up the 15 wind machine. The pneumatic 5 compressor system provides for not only compressing function but also moves the double functional 7 motor generator and/or the 1 generator with use of the stored and compressed 8 air and through the 17 decompressing and regulating valves, thus, it converts the kinetic energy Arisen by air stored and depressed in the 11, 13 containers, into electricity. The 3 Processing unit receives the signals produced by 10 wind-speedometers, respectively Observes and regulates the 4 fin revolution as well, respectively performs all of the Controlling respectively switching function, including the electronical controls of 2a, b Clutch and/or Hardy-disks as well.

### Patent Issues

01.

Procedure for improving the performance of wind and/or water machines with integration of an additional pneumatic system, with the feature that
the (5) compressor and the (7) double-functional driving motor-generator join in
the crankshaft of the (15) wind and/or water machines through the (2a,b) clutch
and/or Hardy-disks, respectively through any such kind of form controlled by the
central (3) processing unit, thereby it develops electricity with utilization of the
Mechanical motion and/or performs (8) air compression.

02.

Procedure on the basis of Patent issue 1, with the feature that
the getting of the (8) air into the (11,13) container comes from use of (5)
pneumatic compressor, operated by mechanical motion through the power of wind
And/or water, respectively from any kind of air compressing procedure.

03.

Procedure on the basis of any former Patent issue, with the feature that

the start of infeed of the air compressed by the (5) compressor, or being emergent

through any kind of technique into the (11,13) containers and/or the length of time

and/of air quantity, is adjustable that may take place through the central (3)

Processing unit and with use of (17) decompressing and regulating valves.

04.

Procedure on the basis of any former Patent issue, with the feature that
the production of the depressed air (8) as well as the rationing through the
decompressing and regulating system (17) take place in dependence of the
intention of the system operator with taking the characteristics of the (5) pneumatic
system into consideration and of objective standing of voltage.

05.

Procedure on the basis of any former demand, clause with the feature that
the functional (3) processing system of the (15) wind and/or water machine
controls the production and rationing of the air (8) compressed by the pneumatic
(5) system and/or of electricity partly or in whole through the decompressing and
regulating system.

06.

Improvement of performance factor of the wind and/or water machines with integration of an additional pneumatic system, where the (8) air compressed by the (15) wind machine, with the feature that
is stored with integration of a (5) pneumatic system in a (13) container placed in
the (9) supporting column and/or in (11) external containers.

07.

Equipment on the basis of the Patent issue 6, with the feature that
the double-functional (7) motor-generator, in operation at (16) wind and/or water of
less flow than usual, which is controlled by the wind-gauge and/or other sensors,
adjusted at lower velocity value, starts up the (4) fin joined in the (15) wind
machine (1) generator.

08.

Equipment on the basis of the Patent issue 6 and 7, with the feature that

the (7) double-functional starting motor-generator, the (5) compressor, the (1)

generator are placed on the same crankshaft.

09.

Equipment on the basis of the Patent issue 6-8, with the feature that

the starting up of the (15) wind and/or water machine happens at smaller (16) wind

and/or water than what kind of wind and/or water could the fins (4) turn.

10.

Equipment on the basis of the Patent issue 6-9, with the feature that
the (15) wind and/or water machine can produce electricity and/or (8) compressed
air that it uses for the production of electricity.

### ENUMERATION OF FIGURE ELEMENTS

1. Generator

2. Electronically controlled clutch and/or Hardy-disk

3. Processing central unit

4. Wind wheel fin

5. Pneumatic compressor

6. Output connector

7. Driving motor generator

8. Compressed air

9. Supporting column

10. Wind-gauge

11. Additional buffer air container

12. Axis

13. Air container placed in column

14. Accumulator

15. Wind machine

16. Wind

17. Decompressing and regulating valve

1. The energy production starts at a lower wind speed.

2. The energy is stored in a non-chemical way.

3. The technology can produce and store energy at the same time.

4. The calm period can reduce for the wind wheel.

5. The energy transmission is not tied to the wind.

6. The energy can be stored and managed at a lower level of loss.

7. The wind wheel can also be started with stored and compressed air.

8. The supporting column of the wind wheel can also be used as energy storage.

9. The fins don't have to be turned away at higher speed levels thus the period of the Power generation and storage can be extended by starting the air compressing equipment Using the clutch

10. Can produce more energy than existing Wind Turbine system and Hydro- Electric Systems by using this Procedure and Equipment with the addition of this pneumatic system.
